(19) United States
(12) Patent Application Publication
(10) Pub. No.: US 2005/0278472 A1
(43) Pub. Date: Dec. 15, 2005

(54) USB extender

(76) Inventor: Justin Thomas Gierke, Lakewood, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/867,083

(22) Filed: Jun. 14, 2004

(51) Int. Cl. G06F 13/00

(52) U.S. Cl. 710/313

(57) ABSTRACT

The present invention relates to a system and method for extending the distance between USB hosts and USB devices. Provided are USB 2.x compatible extenders capable of separating a USB device from a USB host by more than 30 meters while maintaining an at least approximately 480 Mb/sec data rate.

### FIELD OF THE INVENTION

The present invention relates to Universal Serial Bus (USB) communication standards and, more specifically, to a system and method for extending USB connections.

### BACKGROUND OF THE INVENTION

Universal Serial Bus (“USB”) is a peripheral bus standard developed by the PC and telecom industry, including Compaq, DBC, IBM, Intel, Microsoft, NEC and Northern Telecom. USB defines a bus and protocols for the connection of computer peripherals to computers (and computers to each other). “Universal Serial Bus Specification,” Compaq, Intel, Microsoft, NEC, Revision 1.1, Sep. 23, 1998, describes USB and its implementation and is incorporated herein by reference. Proposed and actual USB devices include keyboards, mice, telephones, digital cameras, modems, digital joysticks, CD-ROM drives, tape and floppy drives, digital scanners, printers, MPEG-2 video-base products, data digitizers and other relatively low bandwidth devices—USB version 1.x supports data rates of up to 12 Mb/sec.

In addition to standard USB devices and technologies, a new USB standard 2.x now exists. “Universal Serial Bus Specification,” Compaq, Hewlett-Packard, Intel, Lucent, Microsoft, NEC, Philips, Revision 2.0, Apr. 27, 2000 describes the most current USB 2.x standard and its implementation and is incorporated herein by reference. The USB 2.x standard permits faster data transmission than the USB 1.x standard. For example, USB version 2.x supports data rates of approximately 480 Mb/sec.

USB supports the dynamic insertion and removal of devices from the bus (or “hot-plugging”) and recognizes actual peripherals or functions; hosts (typically a computer); and hubs, which are intermediate nodes in the network that allow the attachment of multiple downstream hubs or functions. Upon insertion of an downstream hub or function, the host/hub on the upstream side of the bus initiates a bus enumeration to identify and configure the new device. Upon removal, the removed device is “forgotten.” Some examples of USB 2.x devices are: digital cameras, CD-ROM burners, DVD drives, flash card readers, scanners, and hard drives.

Due to the stringent electrical signal requirements of USB standard specifications, it is difficult to meet the electrical specifications for USB signaling using simple amplifiers or special cable. Accordingly, a USB cable longer than about 5-10 meters generally will not work, even when using active terminations. In part, extending USB cables beyond about 5-10 meters is difficult because signal symmetry and skew can become compromised. It would be preferable if USB devices could be connected using technology that permits the devices to be more than about 5-10 meters from a host.

One method of increasing the distances between a USB device and a host is to use signal translation to convert USB signals into an alternate signal capable of traveling more than 10 meters without distortion. Unfortunately, even if a USB signal is translated such that the electrical specifications are met, the USB timing specifications tend to limit the length of the extender.

According to USB 2.x standards, answers to messages originating from a host must be received within about 1500 nanoseconds (ns) or the host will generate an error. The 1500 ns limit includes the time required for the message to travel from the host to the peripheral device (referred to as the host to device trip time); the time required for the device to answer the host; and the time required for the message to travel from the device to host (referred to as the device to host trip time).

Also according to USB 2.x standards, a USB 2.x compatible extender must be capable of transmitting data at a rate of at least approximately 480 Mb/sec. Using prior art extension techniques, a USB host and a USB device can be separated by up to approximately 30 meters, by chaining multiple 5 meter extenders, without exceeding the allowable response time.

To extend 2.x USB signals beyond this limit of about 30 meters, an “active” USB extender is typically used. In order to prevent the generation of an error by the host due to response delay, a USB extender can be configured to immediately answer the host with a “not acknowledge” (NAK) response—making it an active extender—while sending the message to the device and awaiting the device's response. Upon receipt of the NAK response, the host will retry the original message. When the host attempts to send the message again, the answer (from the device) may have been received by the extender and be immediately available for delivery to the host. While this type of USB extender allows for longer extensions, it decreases the available bandwidth, it is not transparent, and its implementation in both hardware and software is complex. Further, some USB devices and/or host drivers may not work with this type of extender. It would be preferable if a passive extender were capable of extending USB 2.x devices beyond about 30 meters.

### BRIEF SUMMARY OF THE INVENTION

According to an aspect of the invention, there is provided a USB extender. The USB extender is connectable to a USB host and to a USB device for extending the distance between the USB host and the USB device. The USB extender has the capacity to extend a D+ signal and a D− signal between a USB host and at least one USB device more than 30 meters wherein the data transfer rate between the USB host and USB device is at least approximately 480 Mb/sec and wherein the D+ signal and D− signal are skewed by less than 100 ps.

Also according to the present invention, there is provided a method for extending the distance between a USB host and at least one USB device. The method includes: receiving at a device unit a D+ signal and a D− signal from at least one USB device via a USB communications channel, the D+ and D− signals being at least approximately 480 Mb/sec signals; converting the D+ and D− signals to a single-ended at least approximately 960 Mb/sec signal; transmitting the at least approximately 960 Mb/sec single-ended signal over a non-USB communications channel; receiving at a host unit the at least approximately 960 Mb/sec single-ended signal via the non-USB communications channel; converting the at least approximately 960 Mb/sec single-ended signal to D+ and D− at least approximately 480 Mb/sec signals; and sending the at least approximately 480 Mb/sec D+ and D− signals to a USB host via a USB communications channel; whereby the USB host and the at least one USB device are separated by more than 30 meters.

Also according to the present invention, there is provided another method for extending the distance between a USB host and at least one USB device. The method includes: receiving at a device unit a D+ signal and a D− signal from at least one USB device via a USB communications channel, the D+ and D− signals being at least approximately 480 Mb/sec signals; transmitting the at least approximately 480 Mb/sec D+ and D− signals over a non-USB communications channel; receiving at a host unit the at least approximately 480 Mb/sec D+ and D− signals via the non-USB communications channel; reducing skew between D+ and D− signals resulting from transmission over the non-USB communications channel; and sending the at least approximately 480 Mb/sec D+ and D− signals to a USB host via a USB communications channel; whereby the USB host and the at least one USB device are separated by more than 30 meters.

### BRIEF DESCRIPTION OF THE DRAWINGS

FIG. 1 is a block diagram of a prior art USB extension system;

FIG. 2 is a block diagram of a system with a USB extender of the present invention;

FIG. 3 is a block diagram of an extension system illustrating typical timing requirements for a USB 2.x extender;

FIG. 4A is a block diagram of an embodiment of an exemplary transmitter module;

FIG. 4B is a block diagram of another embodiment of an exemplary transmitter module;

FIG. 5A is a block diagram of an exemplary receiver module;

FIG. 5B is a block diagram of another embodiment of an exemplary receiver module;

FIG. 6 is a flow chart generally illustrating one embodiment of data flow from host to device and from device to host;

FIG. 7 is a flow chart generally illustrating part of one embodiment of the data flow when extending the distance for communication traveling from a USB device to a USB host;

FIG. 8 is a flow chart generally illustrating part of one embodiment of the data flow when extending the distance for communication traveling from a USB host to a USB device;

FIG. 9 is a flow chart generally illustrating part of another embodiment of the data flow when extending the distance for communication traveling from a USB device to a USB host; and

FIG. 10 is a flow chart generally illustrating part of another embodiment data flow when extending the distance for communication traveling from a USB host to a USB device.

### DETAILED DESCRIPTION OF THE INVENTION

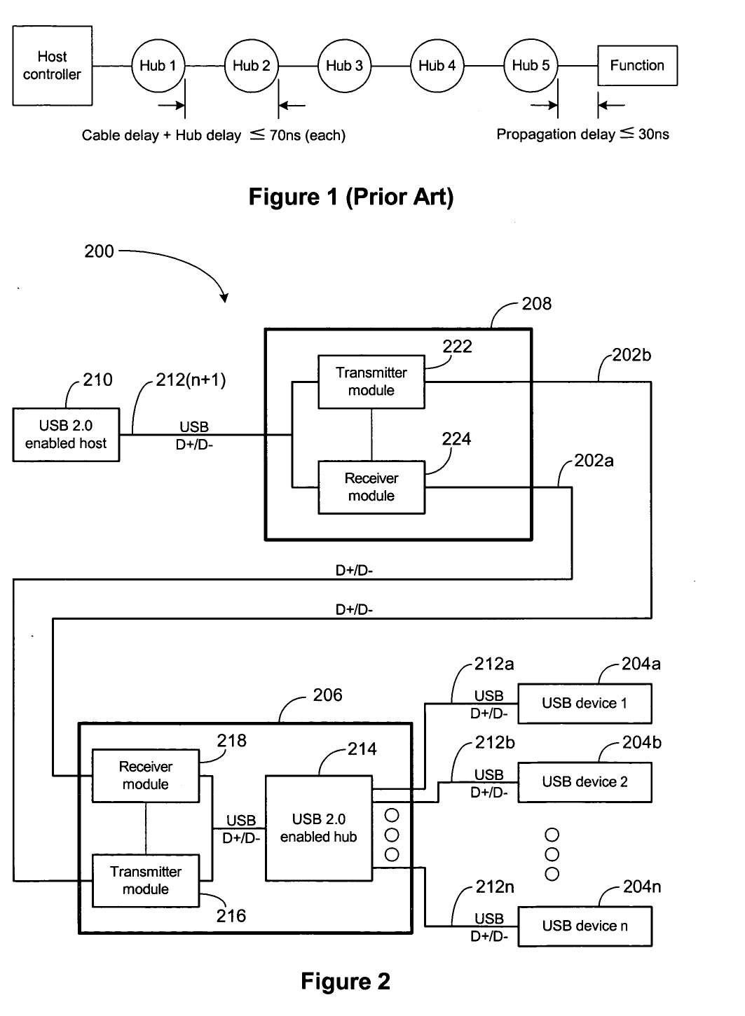

Turning initially to FIG. 1, a diagram illustrating a prior art USB 2.x extension system is provided. The diagram of FIG. 1 can be found in “Universal Serial Bus Specification,” Compaq, Hewlett-Packard, Intel, Lucent, Microsoft, NEC, Philips, Revision 2.0, Apr. 27, 2000 at p. 169. The diagram represents the maximum round-trip delay introduced by extension. As shown, USB extension is accomplished by stringing together multiple short extenders, e.g., 5 meter extenders.

Whether an extender is a 1.x extender or a 2.x extender, a “passive” or an “active” extender, it preferably includes basic functionality to permit the passage of USB commands over extended distances. With all types of extenders, hand-shaking and message transfer typically are addressed as design considerations. An extender should initiate hand-shaking with a host and detect answers from the host. The extender should also answer the hand-shaking initiated by the device. In other words, the USB extender should emulate a device to the host and emulate a host to the device. The extender should also be capable of detecting the direction of each USB message so that the USB message can be transmitted in the correct direction. In addition, the extender should be able to detect or determine the start and end of each message or command.

Turning now to FIG. 2, a block diagram of a system with a USB extender of the present invention is illustrated. The USB extender 200 is generally positioned between a USB host 210 and at least one USB device 204x. The USB host 210 can be any USB 2.x compliant host. Likewise, the USB device 204x can be any USB 2.x compliant device, such as a printer, scanner, digital camera, digital audio player, external drive, etc.

USB extenders can be “passive” type extenders that function like amplifiers of the USB signal. A “passive” type extender is depicted in FIG. 2 and functions to amplify and reshape the USB signal to compensate for increased distances.

Generally, the extender 200 includes a device unit 206 and a host unit 208 30 that are both connectable to a non-USB communications channel 202. The extender 200 is capable of extending the distance between the USB host 210 and the at least one USB device 204x by more than 30 meters. For example, if the USB host 210 is connected to the host unit 208 via a 5 meter USB communications channel 212x and the at least one USB device 204x is connected to the device unit 206 via a 5 meter USB communications channel 212x, the non-USB communications channel would be capable of extending the distance between the host unit 208 and the device unit 206 by more than 20 meters. In addition, the extender 200 is capable of extending the D+ and D− USB data signals such that when the signals arrive at either the USB host 210 or USB device 204x, there is less than 100 ps of skew between the D+ and D− signals.

Referring first to the data path from USB device 204x to USB host 210, the device unit 206 includes a USB hub 214, a device transmitter module 216 and a device receiver module 218. The device unit 206 is configured to receive USB 2.x compatible data from at least one USB device 204x via a USB 2.x communications channel 212x. Accordingly, the device unit 206 is configured to receive a D+ signal and a D− signal with a data rate of at least approximately 480 Mb/sec. The D+ and D− signals are both received by the device unit 206 at the USB hub 214.

In one embodiment, the D+ and D− signals received via the USB hub 214 are sent simultaneously to both the device transmitter module 216 and the device receiver module 218. The device transmitter module 216 and device receiver module 218 may be communicatively coupled and function in a master-slave relationship. In the presently preferred embodiment, the device receiver module 218 functions as master to the device transmitter module 216 and the device transmitter module 216 functions as slave to the device receiver module 218. Thus, the device receiver module 218 may function to enable/disable the device transmitter module 216 from transmitting data. In another embodiment, a switch on the USB line may connect the USB input to the transmitter module 216 and receiver module 218. The switch may be configured to switch the signal between the modules.

The device receiver module 218 may be configured so that it only accepts messages from the non-USB communications channel 202b and ignores any messages originating from a USB device 204x. The device transmitter module 216, however, may be configured to accept messages originating from a USB device 204x and transmit them over the non-USB communications channel 202a to a host unit 208. In addition, the device transmitter module 216 may also be configured to reduce skew introduced during transmission of the D+ and D− signals from the USB device 204x to the device transmitter module 216.

The device transmitter module 216 sends the D+ and D− signals to the host unit 208 via the non-USB communications channel 202a. The host unit 208 includes a host transmitter module 222 and a host receiver module 224. At the host unit 208, the host receiver module 224 is configured to receive D+ and D− data via the non-USB communications channel 202a. Like the device transmitter module 216 and device receiver module 218, the host transmitter module 222 and host receiver module 224 may be communicatively coupled and function in a master-slave relationship. In the presently preferred embodiment, the host receiver module 224 functions as master to the host transmitter module 222 and the host transmitter module 222 functions as slave to the host receiver module 224. Thus, the host receiver module 224 may function to enable/disable the host transmitter module 222 from transmitting data.

The host receiver module 224 may be configured so that it only accepts messages from the non-USB communications channel 202a and ignores any messages originating from a USB host 210. The host transmitter module 222, however, may be configured to accept messages from the USB host 210 and transmit them over a non-USB communications channel 202b to the device unit 206.

The host receiver module 224 may be configured to transmit the received D+ and D− signals to the USB host 210 via a USB communications channel 212x. When the host receiver module 224 transmits to the USB host 210, it may disable the host transmitter module 222 so that the host transmitter module 222 does not receive the data being transmitted from the host receiver module 224 to the USB host 210. In addition, the host receiver module 224 may be configured to reduce skew introduced during transmission of the D+ and D− signals over the non-USB communications channel 202a.

The non-USB communications channel 202 may be any type of non-USB communications channel, such as a fiber optics communication channel or wire-based category 5 (“CAT5”) communications channel or wireless communications channel. Such communication mechanisms include, for example, Ethernet, Token-Ring™, 802.11-type wireless data transmission, or other wire-based or wireless data communication mechanisms as will be apparent to one of ordinary skill in the art. A fiber optics communications channel may provide additional extension capabilities as compared to a copper wire-based communications channel.

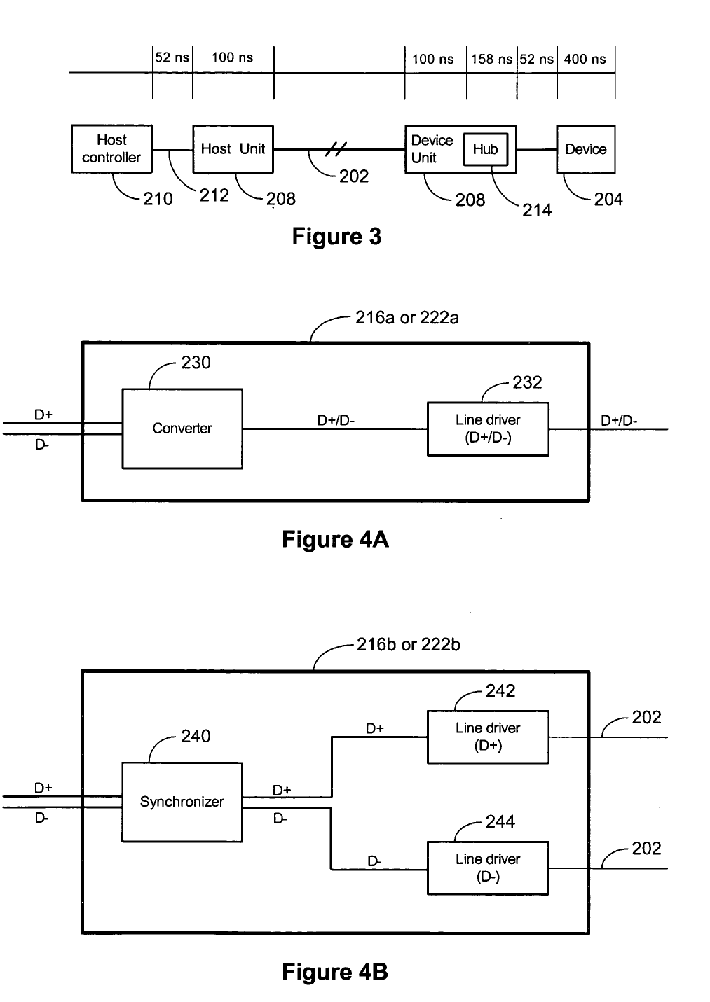

Turning next to FIG. 3, a block diagram illustrating USB 2.x timing requirements is illustrated. According to the USB 2.x specification, the total available trip time is 1500 ns. A typical USB extender will use approximately 52 ns of trip time traveling over a USB cable 212x, approximately 100 ns of circuit delay at the host unit 208, approximately 100 ns of circuit delay at the device unit 206, approximately 158 ns of additional delay if the device unit 206 includes a hub 214, approximately 52 ns of trip time traveling over another USB cable 212x, and approximately 400 ns of response time for the USB device 204x. Accordingly, even before extending the distance between the host unit 208 and the device unit 206, approximately 862 ns of the 1500 ns maximum response time are being used, leaving only approximately 638 ns of travel time over the non-USB communications channel 202. Thus, the maximum one-way trip time for the non-USB communications channel is approximately 319 ns. It will be understood that as technology progresses, the delay introduced by the various system components may decrease, thereby allowing for increased trip time over the non-USB communications channel 202.

Using the approximate 319 ns trip time, one can calculate the approximate maximum length of a wire-based and fiber optic non-USB communications channel 202. Assuming that data travels at approximately 0.299 m/ns over a fiber optic communications channel, the approximate maximum length of a fiber optic non-USB communications channel 202 using the assumed system delay detailed above is 95 m. Likewise, assuming that data travels at approximately 0.225 m/ns over a wire-based communications channel, the approximate maximum length of a wire-based non-USB communications channel 202 using the assumed system delay detailed above is 71 m. In addition, a wireless non-USB communications channel 202 may be used and the length of extension may vary depending on the wireless data transfer technology. In any event, the non-USB communications channel 202 must be capable of transmitting data at a rate of at least approximately 480 Mb/sec.

Turning again to FIG. 2 and referring next to the data path from USB host 210 to USB device 204x, the host unit 208 is configured to receive USB 2.x compatible data from the USB host 210 via a USB 2.x communications channel 212x. Accordingly, the host unit 208 is configured to receive a D+ signal and a D− signal, each of which with a data rate of at least approximately 480 Mb/sec.

The D+ and D− signals received via the USB communications channel 212x are sent simultaneously to both the host transmitter module 222 and the host receiver module 224. The host transmitter module 222, however, may be configured to accept messages from the USB host 210 and transmit them over the non-USB communications channel 202b to the device unit 206. In addition, the host transmitter module 222 may also be configured to reduce skew introduced during transmission of the D+ and D− signals from the USB host 210 to the host transmitter module 222. In another embodiment, a switch on the USB line may connect the USB input to the transmitter module 222 and receiver module 224. The switch may be configured to switch the signal between the modules.

The host transmitter module 222 thus sends the D+ and D− signals to the device unit 206 via the non-USB communications channel 202b. At the device unit 206, the device receiver module 218 is configured to receive D+ and D− data via the non-USB communications channel 202b. The device receiver module 218 may be configured so that it only accepts messages from the non-USB communications channel 202b and ignores any messages originating from a USB device 204x.

The device receiver module 218 may be configured to transmit the received D+ and D− signals to a USB device 204x via a USB hub 214 and a USB communications channel 212x. When the device receiver module 218 transmits to the USB device 204x, it may disable the device transmitter module 216 so that the device transmitter module 216 does not receive the data being transmitted from the device receiver module 218 to the USB device 204x. In addition, the device receiver module 218 may be configured to reduce skew introduced during transmission of the D+ and D− signals over the non-USB communications channel 202b.

Turning next to FIG. 4A, an exemplary transmitter module, such as the device transmitter module 216a or the host transmitter module 222a, for one embodiment of the present invention is provided. Both the device transmitter module 216a and the host transmitter module 222a are configured to receive USB D+ and D− signals originating from a USB device, such as a USB device 204x, or a USB host, such as USB host 210, respectively. The transmitter module is preferably capable of accepting differential signals (D+ and D− signals) of at least approximately 480 Mb/sec, such as by way of a USB communications channel and/or USB hub.

When the transmitter module 216a or 222a receives the at least approximately 480 Mb/sec D+ and D− signals, the D+ and D− signals are converted by a differential to single-ended converter 230 to a single-ended signal capable of least approximately 960 Mb/sec. The differential to single-ended converter 230 may be a control circuit implemented as one or combinations of the following: programmable circuit, integrated circuit, memory and I/O circuits, an application specific integrated circuit, microcontroller, complex programmable logic device, field programmable gate arrays, other programmable circuits, or the like.

When the differential to single-ended converter 230 receives the D+ and D− signals, it may function to simply combine the D+ value and D− value into a multi-bit protocol. An example of two-bit protocol is illustrated by the following table:

| D+ | D− | Converter Output |
|---|---|---|
| 0 | 1 | 01 |
| 1 | 0 | 10 |
| 0 | 0 | 00 |
| 1 | 1 | 11 |

The differential to single-ended converter may also function to reduce or substantially eliminate skew introduced between the D+ and D− signals during transmission over the USB communications channel 202 from the USB host 210 or a USB device 204x. Standard synchronizers are known in the art for eliminating up to about 100 ps of skew. In the case where more than 100 ps of skew is introduced during transmission from the USB host 210 or a USB device 204x, the converter 230 may also contain additional logic and a dual buffer to compare the D+ and D− lines, such as by way of a first in first out (“FIFO”) comparison.

It will be understood by those skilled in the art that in order to maintain the same data transmission speed over a single line that was achieved by sending data over two lines, the speed of the single-line transmission must be at twice as fast as the two-line transmission to prevent a bottleneck effect. Accordingly, in order to comply with USB 2.x standards, which requires that USB D+ and D− signals be transmitted at a rate of at least approximately 480 Mb/sec, the single-ended transmission must have a data rate of at least approximately 960 Mb/sec. Thus, it may be preferable to use fiber optic cable for the non-USB communications channel 202 instead of a wire-based or wireless communications channel, which may be less desirable for transmitting data at high speeds.

The differential to single-ended converter 230 is configured to transmit its output to a line driver 232, which may be a standard transmitter of an appropriate type determined by the media of the non-USB communications channel 202. If the non-USB communications channel 202 is a wire-based communications channel, such as CAT5 wire, the line driver 232 may be an RS485 transmitter, or the like. Similarly, if a wireless non-USB communications channel 202 is utilized, the line driver 232 may be a wireless transmitter. The transmitter for wireless and wire-based communications channels may be amplitude modulated or frequency modulated. Further, if the non-USB communications channel 202 is a fiber optic communications channel, as in the presently preferred embodiment, the line driver 232 may be a transmitter such as a light emitting diode (“LED”) or laser diode (“LD”) or the like. In addition, the fiber optic transmitter may be intensity modulated.

Turning next to FIG. 4B, an exemplary transmitter module, such as the device transmitter module 216b or the host transmitter module 222b, for another embodiment of the present invention is provided. Both the device transmitter module 216b and the host transmitter module 222b are configured to receive USB D+ and D− signals originating from a USB device or a USB host, respectively. The transmitter module is preferably capable of accepting differential signals (D+ and D− signals) of at least approximately 480 Mb/sec, such as by way of a USB communications channel and/or a USB hub 214.

When the transmitter module 216b or 222b receives at least approximately 480 Mb/sec D+ and D− signals, a synchronizer 240 functions to reduce or substantially eliminate skew introduced between the at least approximately 480 Mb/sec D+ and D− signals during transmission over the USB communications channel 202 from the USB host 210 or a USB device 204x. Standard synchronizers are known in the art for eliminating up to about 100 ps of skew. In the case where more than 100 ps of skew is introduced during transmission from a USB host or a USB device, the synchronizer 240 may also contain additional logic and a dual buffer to compare the D+ and D− lines, such as by way of a FIFO comparison.

Thus, the synchronizer 240 receives the at least approximately 480 Mb/sec D+ and D− signals, synchronizes the at least approximately 480 Mb/sec D+ and D− signals, and transmits each of the at least approximately 480 Mb/sec D+ and D− signals to separate line drivers. The D+ signal is transmitted to the D+ line driver 242 and the D− signal is transmitted to the D− line driver 244.

The synchronizer 240 may be a control circuit implemented as one or combinations of the following: programmable circuit, integrated circuit, memory and I/O circuits, an application specific integrated circuit, microcontroller, complex programmable logic device, field programmable gate arrays, other programmable circuits, or the like.

The line drivers 242 and 244 may be standard transmitters of an appropriate type determined by the type of media of the non-USB communications channel 202. If the non-USB communications channel 202 is a wire-based communications channel, such as CAT5 wire, the line drivers 242 and 244 may be RS485 transmitters, or the like. Similarly, if a wireless non-USB communications channel 202 is utilized, the line drivers 242 and 244 may be wireless transmitters. The transmitters for wireless and wire-based communications channels may be amplitude modulated or frequency modulated. Further, if the non-USB communications channel 202 is a fiber optic communications channel the line drivers 242 and 244 may be transmitters such as a LEDs or LDs or the like. In addition, the fiber optic transmitters may be intensity modulated.

The number of “channels” required to transmit the D+ and D− signals across the non-USB communications channel 202 may be determined by both the type of transmitter 216x or 222x and the type of media of the non-USB communications channel 202. For example, the transmitter 216b or 222b requires two “channels” for transmitting the D+ and D− signals. The transmitter 216a or 222a, however, requires only a single “channel” for transmitting the D+ and D− signals. If the non-USB communications channel 202 is wire-based, the D+ and D− signals may be transmitted over a single wire pair. However, if the non-USB communications channel 202 is a fiber optic communications channel, the D+ and D− signal would likely be transmitted over two fiber cables—one for the D+ signal and one for the D− signal.

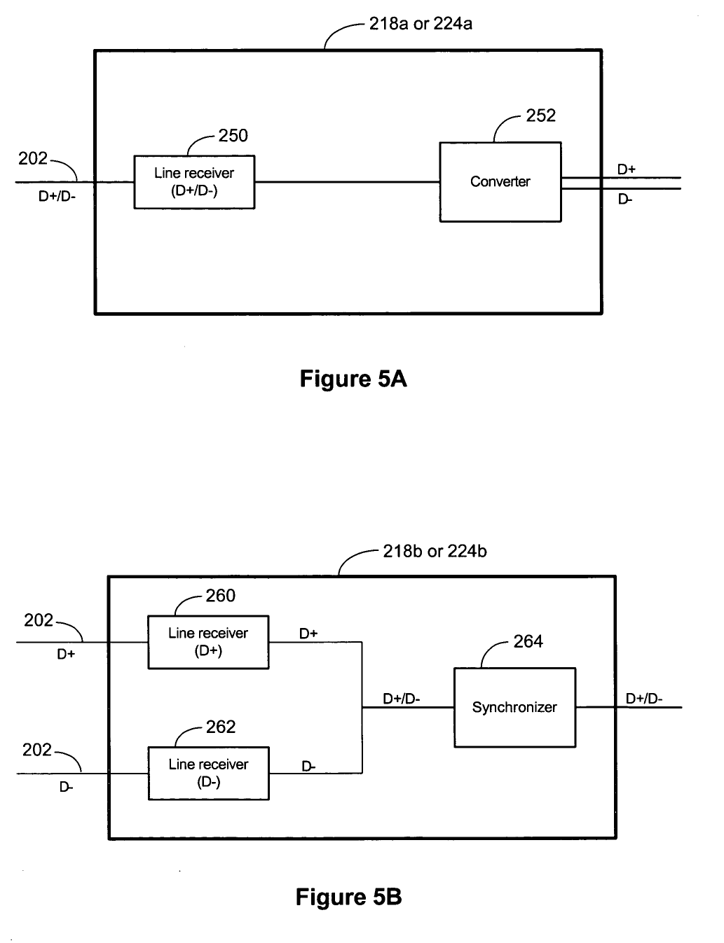

Turning now to FIG. 5A, an exemplary receiver module 218a or 224a, such as the device receiver module 218 or the host receiver module 224, for the embodiment of the invention partially illustrated in FIG. 4A is provided. Both the device receiver module 218a and the host receiver module 224a are configured to receive an at least approximately 960 Mb/sec single-ended signal. For example, the device receiver module 218a is configured to receive a signal generated by the host transmitter module 222a and transmitted over the non-USB communications channel 202b. Similarly, the host receiver module 224a is configured to receive a signal generated by the device transmitter module 216a and transmitted over the non-USB communications channel 202a.

The receiver module 218a or 224a includes a line receiver 250, which may be a receiver of an appropriate type determined by the media of the non-USB communications channel media. The line receiver 250 receives the at least approximately 960 Mb/sec single-ended signal and sends it to a single-ended to differential converter 252. The line receiver 250 may also perform amplification and/or filtering to improve the quality of the signals received at the receiver module 218a or 224a.

If the non-USB communications channel 202 is a wire-based communications channel, such as CAT5 wire, the line receiver 250 may be a RS485 receiver, or the like. Similarly, if a wireless non-USB communications channel 202 is utilized, the line receiver 250 may be a wireless receiver. The receiver for wireless and wire-based communications channels may be amplitude modulated or frequency modulated. Further, if the non-USB communications channel 202 is a fiber optic communications channel the line receiver 250 may be a receiver such as a photo diode or the like. In addition, the fiber optic receiver may be intensity modulated. The line receiver 250 may also include a control circuit implemented as one or combinations of the following: programmable circuit, integrated circuit, memory and I/O circuits, an application specific integrated circuit, microcontroller, complex programmable logic device, field programmable gate arrays, other programmable circuits, or the like.

The single-ended to differential converter 252 separates the at least approximately 960 Mb/sec single-ended signal into discrete at least approximately 480 Mb/sec D+ and D− signals, which are then output to either the USB host 210 or the USB device 204x, either directly or via a USB hub 214. When the single-ended to differential converter 252 receives the D+ and D− signals, it may function to simply separate the single-ended signal into separate D+ and D− values using the same conversion table used by the differential to single-ended converter 230 to combine the D+ and D− signals before transmission over the non-USB communications channel 202.

The single-ended to differential converter 252 may be a control circuit implemented as one or combinations of the following: programmable circuit, integrated circuit, memory and I/O circuits, an application specific integrated circuit, microcontroller, complex programmable logic device, field programmable gate arrays, other programmable circuits, or the like.

Turning now to FIG. 5B, an exemplary receiver module 218b or 224b, such as the device receiver module 218 or the host receiver module 224, for the embodiment of the invention partially illustrated in FIG. 4B is provided. The device receiver module 218b is configured to receive a signal generated by the host transmitter module 222b and transmitted over the non-USB communications channel 202. Similarly, the host receiver module 224b is configured to receive a signal generated by the device transmitter module 216b and transmitted over the non-USB communications channel 202.

Specifically, the receiver module 218b or 224b is configured to receive at least approximately 480 Mb/sec D+ and D− signals from the transmitter module 216b or 222b via the non-USB communications channel 202. The receiver module 218b or 224b includes two line receivers 260 and 262, which may each be a receiver of an appropriate type determined by the non-USB communications channel media. Each of the line receivers 260 and 262 is configured to receive one of the at least 480 approximately Mb/sec D+ and D− signals. After the line receivers 260 and 262 receive the D+ and D− signals, they send the received signals to a synchronizer 264. The line receivers 260 and 262 may also perform amplification and/or filtering to improve the quality of the signals received at the receiver module 218b or 224b.

If the non-USB communications channel 202 is a wire-based communications channel, such as CAT5 wire, the line receivers 260 and 262 may be RS485 receivers, or the like. Similarly, if a wireless non-USB communications channel 202 is utilized, the line receivers 260 and 262 may be wireless receivers. The receivers for wireless and wire-based communications channels may be amplitude modulated or frequency modulated. Further, if the non-USB communications channel 202 is a fiber optic communications channel, the line receivers 260 and 262 may be receivers such as photo diodes or the like. In addition, the fiber optic receivers may be intensity modulated. The line receivers 260 and 262 may also include a control circuit implemented as one or combinations of the following: programmable circuit, integrated circuit, memory and I/O circuits, an application specific integrated circuit, microcontroller, complex programmable logic device, field programmable gate arrays, other programmable circuits, or the like.

The synchronizer 264 is configured to receive the at least approximately 480 Mb/sec D+ and D− signals and reduce or substantially eliminate skew between the D+ and D− signals introduced during transmission over the non-USB communications channel 202. Standard synchronizers are known in the art for eliminating up to about 100 ps of skew. In the case where more than 100 ps of skew is introduced during transmission from a USB host or a USB device, the synchronizer 264 may also contain additional logic and a dual buffer to compare the D+ and D− lines, such as by way of a FIFO comparison.

Thus, the synchronizer 264 receives the at least approximately 480 Mb/sec D+ and D− signals, synchronizes the at least approximately 480 Mb/sec D+ and D− signals, and transmits each of the at least approximately 480 Mb/sec D+ and D− signals to either the USB host 210 or a USB device 204x either directly or via a USB hub 214. The synchronizer 264 may be a control circuit implemented as one or combinations of the following: programmable circuit, integrated circuit, memory and I/O circuits, an application specific integrated circuit, microcontroller, complex programmable logic device, field programmable gate arrays, other programmable circuits, or the like.

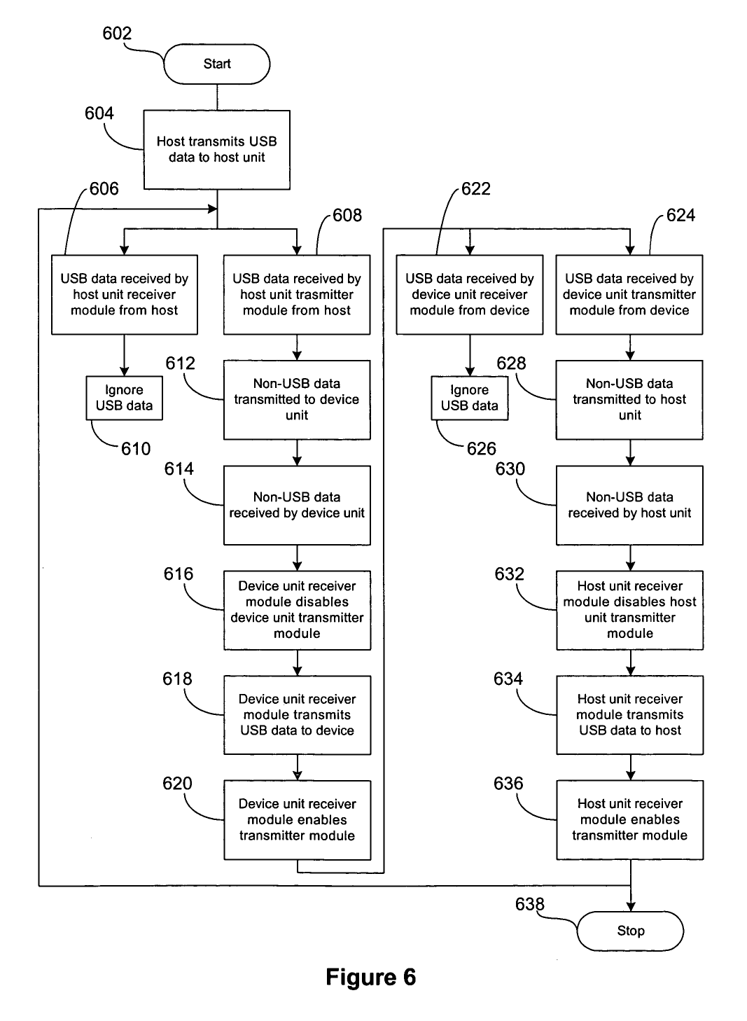

Turning now to FIG. 6, a flow chart generally illustrating one embodiment of data flow from host to device and from device to host is provided. The basic flow commences at start block 602 from which progress is made to process block 604. At process block 604, a USB 2.x enabled host such as USB host 210 transmits USB data to a host unit 208.

Flow then continues to both process blocks 606 and 608. At process block 606, the USB data is received by the host unit receiver module 224. At process block 608 the USB data is received by the host unit transmitter module 222. From process block 606 flow progresses to process block 610 wherein the USB data received by the receiver module 224 is ignored. From process block 608 progression then continues to process block 612 wherein non-USB data is transmitted from a host unit 208 to a device unit 206.

Progression then flows to process block 614 wherein the non-USB data is received by the device unit 206. Progression then continues to process block 616 wherein a device unit receiver module 218 disables a device unit transmitter module 216. Flow then progresses to process block 618 wherein the device unit receiver module 218 transmits USB data to a USB device 204x either directly or via a USB hub 214.

Progression then flows to process block 620 wherein the device unit receiver module 218 enables the device unit transmitter module 216. Flow then continues to both process block 622 and process block 624. At process block 622, USB data is received by the device unit receiver module 218 from a device 204x. At process block 624, USB data is received by a device unit transmitter module 216 from a device, such as the device 204x. From process block 622 flow progresses to process block 626 wherein the USB data received by the receiver module 218 is ignored.

Progression then continues from process block 624 to process block 628 wherein non-USB data is transmitted to the host unit 208. Flow then continues to process block 630 wherein the non-USB data is received by the host unit 208. Progression then flows to process block 632 wherein the host unit receiver module 224 disables the host unit transmitter module 222. Flow then continues to process block 634 wherein host unit receiver module 224 transmits USB data to the USB host 210. Progression then continues to process block 636 wherein the host unit receiver module 224 enables to the host unit transmitter module 222. Progression then may loop back to both process blocks 606 and 608 or progression may continue to termination block 638.

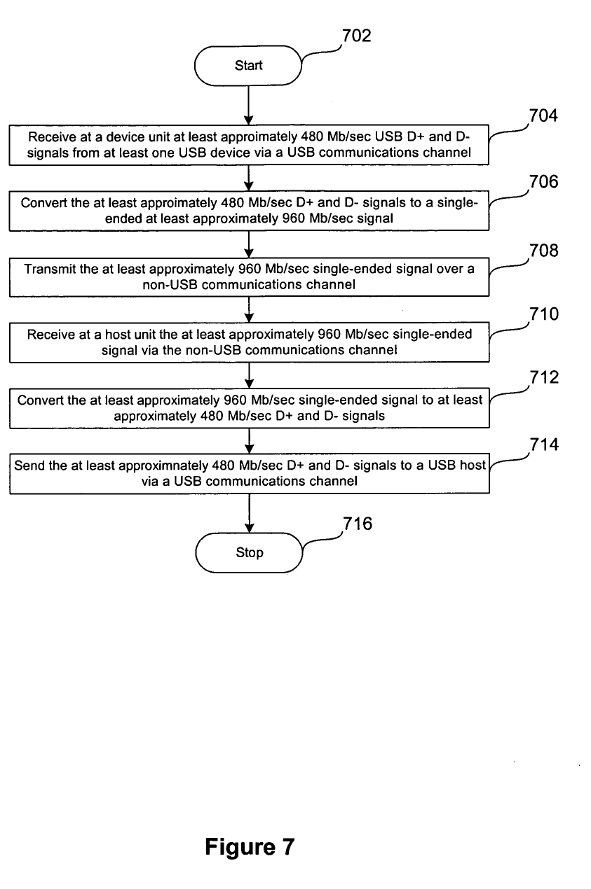

Turning next to FIG. 7, a flow chart generally illustrating part of one embodiment of the data flow when extending the distance for communication traveling from a USB device to a USB host is provided. Flow begins at start block 702 from which progression continues to process block 704 wherein a device unit 206 receives the at least approximately 480 Mb/sec USB D+ and D− signals from at least one USB device 204x via a USB communications channel 212x. Flow continues to process block 706 wherein the D+ and D− signals are converted to an at least approximately 960 Mb/sec single-ended signal. Progression then flows to process block 708 wherein the at least approximately 960 Mb/sec single ended-signal is transmitted over a non-USB communications channel 202.

Flow then progresses to process block 710 wherein the host unit 208 receives the at least approximately 960 Mb/sec single-ended signal via the non-USB communications channel 202. Progression then continues to process block 712 wherein the at least approximately 960 Mb/sec single-ended signal is converted to the at least approximately 480 Mb/sec D+ and D− signals. Flow then progresses to process block 714 wherein the at least approximately 480 Mb/sec D+ and D− signals are sent to a USB host 210 via a USB communications channel 202. Progression then continues to termination block 716.

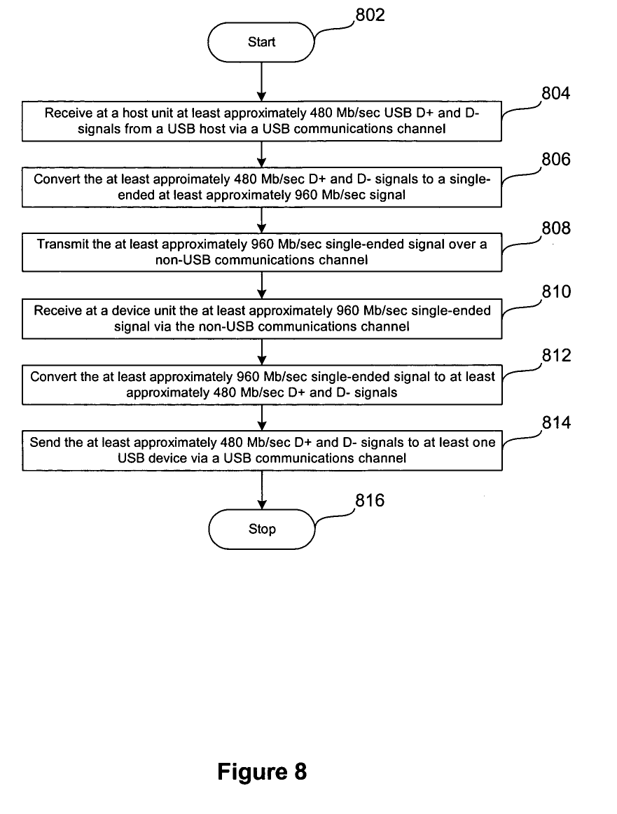

Turning next to FIG. 8, a flow chart generally illustrating part of one embodiment of the data flow when extending the distance for communication traveling from a USB host to a USB device is provided. Flow commences at start block 802 from which progression flows to process block 804. At process block 804 a host unit receives the at least approximately 480 Mb/sec USB D+ and D− signals from a USB host 210 via a USB communications channel 202. Flow then continues to process block 806 wherein the at least approximately 480 Mb/sec D+ and D− signals are converted to a single-ended at least approximately 960 Mb/sec signal.

Flow then continues to process block 808 wherein the at least approximately 960 Mb/sec single-ended signal is transmitted over a non-USB communications channel 202. Progression then flows to process 810 wherein a device unit 206 receives the at least approximately 960 Mb/sec single-ended signal via the non-USB communications channel 202. Progression then continues to process block 812 wherein the at least approximately 960 Mb/sec single-ended signal is converted to at least approximately 480 Mb/sec signals. Flow then progresses to process block 814 wherein the at least approximately 480 Mb/sec D+ and D− signals are sent to at least one USB device 204x either directly via a USB communications channel 212x or via a USB hub 214. Progression then continues to termination block 816.

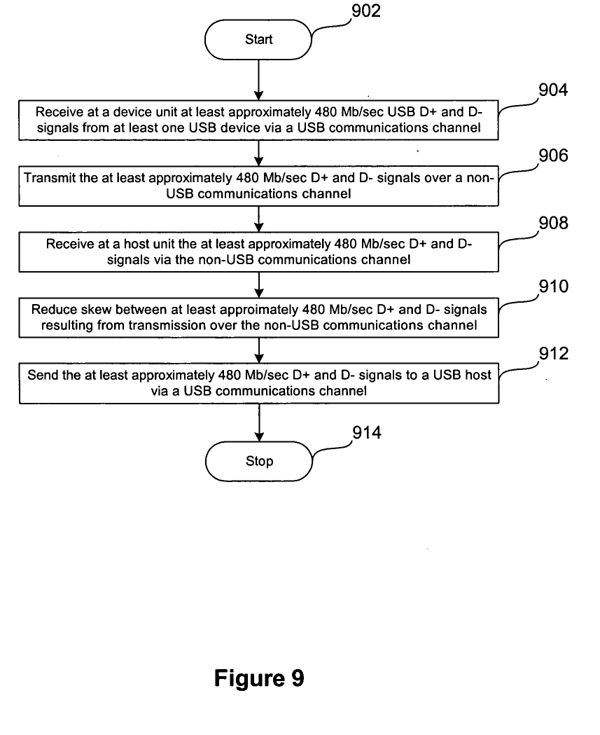

Turning now to FIG. 9, a flow chart generally illustrating part of another embodiment of the data flow when extending the distance for communication traveling from a USB device to a USB host is provided. The basic flow commences at start block 902, from which progression is made to process block 904. At process block 904, a device unit 206 receives the at least approximately 480 Mb/sec USB D+ and D− signals from at least one USB device 204x via a USB communications channel 212x. Flow progresses to process block 906 wherein the at least approximately 480 Mb/sec D+ and D− signals are transmitted to a host unit 208 via a non-USB communications channel 202.

Progression then continues to process block 908 wherein a host unit 208 receives the at least approximately 480 Mb/sec D+ and D− signals via the non-USB communications channel 202. Progression then continues to process block 910 wherein skew between the D+ and D− signals resulting from transmission over the non-USB communications channel 202 is reduced or substantially eliminated. Flow continues to process block 912 wherein the at least approximately 480 Mb/sec D+ and D− signals are set to a USB host 210 via a USB communications channel 212x. Progression then continues to termination block 914.

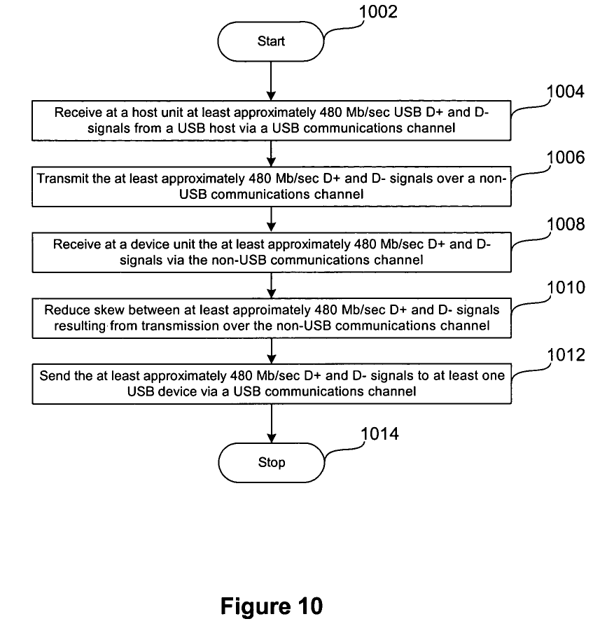

Turning now to FIG. 10, a flow chart generally illustrating part of another embodiment data flow when extending the distance for communication traveling from a USB host to a USB device is provided. Flow commences at start block 1002, from which progression is made to process block 1004. At process block 1004, a host unit 208 receives the at least approximately 480 Mb/sec USB D+ and D− signals from a USB host 210 via a USB communications channel 212x. Progression then continues to process block 1006 wherein at least approximately 480 Mb/sec D+ and D− signals are transmitted to a device unit 206 via a non-USB communications channel 202.

Progression then continues to process block 1008 wherein a device unit 206 receives the at least approximately 480 Mb/sec D+ and D− signals via the non-USB communications channel 202. Flow then continues to process block 1010 wherein skew between D+ and D− signals resulting from transmission over the non-USB communications channel is reduced. Progression then continues to process block 1012 wherein the at least approximately 480 Mb/sec D+ and D− signals are sent to at least one USB device 204x via a USB communications channel 212x of via a USB hub 214x. Progression then continues to termination block 1014.

While the present invention has been described in association with several exemplary embodiments, the described embodiments are to be considered in all respects as illustrative and not restrictive. Such other features, aspects, variations, modifications, and substitution of equivalents may be made without departing from the spirit and scope of this invention which is intended to be limited solely by the scope of the following claims. Also, it will be appreciated that features and parts illustrated in one embodiment may be used, or may be applicable, in the same or in a similar way in other embodiments.

1. A USB extender connectable to a USB host and to a USB device for extending the distance between the USB host and the USB device, the USB extender having the capacity to extend a D+ signal and a D− signal between a USB host and at least one USB device more than 30 meters wherein the data transfer rate of the D+ and D− signals between the USB host and USB device is at least approximately 480 Mb/sec and wherein the D+ signal and D− signal are skewed by less than 100 ps.

2. The USB extender of claim 1 wherein the USB extender is connectable to a non-USB communications channel and wherein the D+ and D− signals are transmitted over the non-USB communications channel.

3. The USB extender of claim 2 wherein the non-USB communications channel comprises at least one of: copper wire, optical fiber, and wireless.

4. The USB extender of claim 3 wherein the D+ signal is transmitted over one wire of a copper wire pair and the D− signal is transmitted over the other wire of the copper wire pair.

5. The USB extender of claim 3 wherein the D+ signal and D− signals are transmitted on separate optical fiber cables.

6. The USB extender of claim 3 wherein the D+ and D− signal are combined into a single-ended at least approximately 960 Mb/sec signal.

7. The USB extender of claim 6 wherein the single-ended at least approximately 960 Mb/sec signal is transmitted over a single optical fiber cable.

8. The USB extender of claim 1 wherein the USB extender is connectable to a USB host and to at least one USB device via USB communications channels.

9. The USB extender of claim 1 wherein the USB extender is configured to accept any USB device.

10. The USB extender of claim 1 wherein the USB extender is connectable to multiple USB devices.

11. The USB extender of claim 1 wherein the USB extender extends the distance between a USB host and a USB device without emulating either the USB host or the USB device.

12. The USB extender of claim 1 wherein the USB extender is a passive extender.

13. A USB extender assembly, comprising:
the USB extender of claim 1;
a non-USB communications channel;
at least one USB device; and
a USB host.

14. The USB extender of claim 13 wherein the USB extender comprises:
a host unit connectable to the USB host and the non-USB communications channel; and
a device unit connectable to the USB device and the non-USB communications channel.

15. The USB extender of claim 14 wherein the device unit further comprises a hub connectable to multiple USB devices.

16. The USB extender of claim 14 wherein the host unit and device each comprise:
a transmitter module having a transmitter for receiving USB data from the USB host or the USB device and transmitting the received USB data over a non-USB communications channel; and
a receiver module having a receiver for receiving data from the non-USB communications channel and transmitting the received USB data to the USB host or the USB device.

17. The USB extender of claim 16 wherein both the transmitter and receiver modules are communicably coupled and function in a master-slave relationship.

18. The USB extender of claim 17 wherein the receiver module is the master and the transmitter module is the slave.

19. The USB extender of claim 16 wherein the transmitter comprises at least one of a copper wire transmitter, a wireless transmitter, and a optical transmitter.

20. The USB extender of claim 16 wherein the transmitter module comprises:
a synchronizer for synchronizing the D+ and D− signals and decrease skew introduced between the extender and the USB host or USB device; and
a transmitter for each of the D+ and D− for transmitting the D+ and D− signals over the non-USB communications channel.

21. The USB extender of claim 16 wherein the receiver module comprises:
a receiver for each of the D+ and D− signals for receiving the D+ and D− signals transmitted over the non-USB communications channel; and
a synchronizer for synchronizing the D+ and D− signals and decrease skew introduced between the host unit and the device unit.

22. The USB extender of claim 16 wherein the transmitter module comprises a differential to single-ended converter, wherein the USB data received by the transmitter is first converted by the differential to single-ended converter and wherein the transmitter is a single-ended transmitter.

23. The USB extender of claim 16 wherein the receiver module comprises: a single-ended receiver for receiving converted single-ended USB data from the non-USB communications channel and a single-ended to differential converter.

24. A method for extending the distance between a USB host and at least one USB device, the method comprising:
receiving at a device unit a D+ signal and a D− signal from at least one USB device via a USB communications channel, the D+ and D− signals being at least approximately 480 Mb/sec signals;
converting the D+ and D− signals to a single-ended at least approximately 960 Mb/sec signal;
transmitting the at least approximately 960 Mb/sec single-ended signal over a non-USB communications channel;
receiving at a host unit the at least approximately 960 Mb/sec single-ended signal via the non-USB communications channel;
converting the at least approximately 960 Mb/sec single-ended signal to at least approximately 480 Mb/sec D+ and D− signals; and
sending the at least approximately 480 Mb/sec D+ and D− signals to a USB host via a USB communications channel;
whereby the USB host and the at least one USB device are separated by more than 30 meters.

25. The method of claim 24 further comprising:
receiving at a host unit a D+ signal and a D− signal from a USB host via a USB communications channel, the D+ and D− signals being at least approximately 480 Mb/sec signals;
converting the D+ and D− signals to a single-ended at least approximately 960 Mb/sec signal;
transmitting the at least approximately 960 Mb/sec single-ended signal over a non-USB communications channel;
receiving at a device unit the at least approximately 960 Mb/sec single-ended signal via the non-USB communications channel;
converting the at least approximately 960 Mb/sec single-ended signal to at least approximately 480 Mb/sec D+ and D− signals; and
sending the at least approximately 480 Mb/sec D+ and D− signals to at least one USB device via a USB communications channel.

26. A method for extending the distance between a USB host and at least one USB device, the method comprising:
receiving at a device unit a D+ signal and a D− signal from at least one USB device via a USB communications channel, the D+ and D− signals being at least approximately 480 Mb/sec signals;
transmitting the at least approximately 480 Mb/sec D+ and D− signals over a non-USB communications channel;
receiving at a host unit the at least approximately 480 Mb/sec D+ and D− signals via the non-USB communications channel;
reducing skew between D+ and D− signals resulting from transmission over the non-USB communications channel; and
sending the at least approximately 480 Mb/sec D+ and D− signals to a USB host via a USB communications channel;
whereby the USB host and the at least one USB device are separated by more than 30 meters.

27. The method of claim 26 further comprising:
receiving at a host unit a D+ signal and a D− signal from a USB host via a USB communications channel, the D+ and D− signals being at least approximately 480 Mb/sec signals;
transmitting the at least approximately 480 Mb/sec D+ and D− signals over a non-USB communications channel;
receiving at a device unit the at least approximately 480 Mb/sec D+ and D− signals via the non-USB communications channel;
reducing skew between D+ and D− signals resulting from transmission over the non-USB communications channel; and
sending the at least approximately 480 Mb/sec D+ and D− signals to at least one USB device via a USB communications channel.
